(19) United States
(12) Patent Application Publication
(10) Pub. No.: US 2024/0099516 A1
(43) Pub. Date: Mar. 28, 2024

(54) AUTOMATICALLY ADJUSTABLE COFFEE MACHINE AND ASSOCIATED COFFEE-BEAN CONTAINER

(71) Applicant: NEXT LEVEL COFFEE GMBH, Konstanz (DE)

(72) Inventors: Marius KÜTEMEYER, Stuttgart (DE); Dominik MAIER, Konstanz (DE); Markus UNGER, Konstanz (DE)

(73) Assignee: NEXT LEVEL COFFEE GMBH, Konstanz (DE)

(21) Appl. No.: 18/276,085

(22) PCT Filed: Feb. 4, 2022
(86) PCT No.: PCT/EP2022/052665

§ 371 Date: Aug. 7, 2023

(30) Foreign Application Priority Data
Feb. 5, 2021 (DE) 10 2021 102 743.8

(51) Int. Cl. A47J 42/44; A47J 31/42; A47J 31/44; A47J 31/46; A47J 31/52; A47J 42/50; A47J 42/56

(52) U.S. Cl. CPC A47J 42/44; A47J 31/42; A47J 31/4492; A47J 31/465; A47J 31/5253; A47J 31/5255; A47J 42/50; A47J 42/56

(57) ABSTRACT

A coffee machine, a coffee bean container, and a system including a coffee machine and a coffee bean container are described. The coffee bean container has an identification element that is read by the coffee machine when the coffee bean container is placed on the coffee machine. Based on the information read from the identification element, a parameter set is applied to the coffee machine and the coffee machine is individually adjusted for the coffee bean container placed on it.

### CROSS-REFERENCE TO RELATED APPLICATIONS

This application is the U.S. National Phase of PCT/EP2022/052665 Filed Feb. 4, 2022, which claims Priority to DE 10 2021 102 743.8 Filed Feb. 5, 2021, the entire disclosures of which are incorporated by reference herein.

### TECHNICAL FIELD

The present disclosure relates to the technical field of machine preparation of coffee drinks, in particular a coffee machine, a coffee bean container (coffee bean hopper) for use with said coffee machine, and a system comprising a coffee machine and a coffee bean container.

### BACKGROUND

Coffee drinks have been consumed for a long time. The general principle is basically always the same: a coffee bean is roasted, then the roasted coffee bean is ground into ground coffee, then a liquid, usually hot water, is applied to the ground coffee. In this last step, the liquid absorbs flavors from the ground coffee and can be consumed as a coffee drink.

There are various manual and machine options for preparing coffee drinks. In particular, the machines for the preparation of coffee drinks enjoy great popularity.

Coffee machines can be designed according to different principles. Usually, a coffee machine contains a reservoir for ground coffee. Hot water is then fed through the ground coffee and subsequently collected in a drinking vessel.

The ground coffee reservoir may be sized to hold ground coffee for one or more servings of the coffee drink. The ground coffee can either be introduced into the reservoir in ground state, or coffee beans can be ground first and immediately prior to brewing, and the resulting ground coffee is then introduced into the reservoir. The liquid is then either applied to the ground coffee under pressure or it flows through the ground coffee without pressure merely under the effect of gravity. Other coffee machines are designed to hold pre-portioned ground coffee in a variety of containers and feed hot water through these containers.

A fundamental difference between the existing types of coffee machines is whether the roasted coffee beans are freshly ground before the brewing process or whether the ground coffee is already in the ground state. For a high-quality coffee drink, it can be advantageous and desirable to grind the coffee beans only immediately before the brewing process, because the ground coffee can lose flavor and aroma if left to stand for a long time.

### SUMMARY

It can be considered an object to simplify and make more flexible the manufacturing process of coffee drinks including the grinding process of coffee beans, so that coffee drinks based on different coffee beans and with a different setting of the coffee machine can be produced in any and changing order with one coffee machine without much effort.

One or more objects are solved by the embodiments described herein.

According to a first aspect, a coffee machine is disclosed having a housing, a coffee bean container receiving arrangement, and a grinder. The coffee bean container receiving arrangement is configured to receive a coffee bean container. The grinder is configured to grind coffee beans. The coffee bean container receiving arrangement may include a container holder and an actuator. The container holder is configured to receive a coffee bean container. The actuator is arranged and configured to move a closing device from an open state to a closed state and vice versa. The closing device is arranged on the container holder or the coffee bean container, and the closing device is arranged to selectively close or open an inlet opening on the container holder or the coffee bean container. The actuator is further configured to move the closing device from the open state to the closed state after an adjustable period of time, thereby presetting a quantity of coffee beans to be fed to the grinder. The coffee machine further may include a detection device, which is designed to detect and read an identification of a coffee bean container. The coffee machine is designed to set the time period after which the closing device is moved from the open state to the closed state depending on the detected identification of the coffee bean container.

This design allows the coffee machine to adjust the amount of coffee beans needed to make one serving of coffee. The coffee bean container is placed on or coupled to the inlet opening of the coffee bean container receiving arrangement so that coffee beans that fall out of the coffee bean container are fed to the grinder. The closing device opens and closes the inlet opening. Because the time period between the opening and closing of the inlet opening is fixed, the amount of coffee beans dropped out is predetermined or influenced thereby. In other words, the amount of coffee beans let through is determined by the length of time the inlet opening is open.

The closing device can be, for example, a flap or a slide, which is guided into the inlet opening by a translatory or rotatory movement, thus preventing further coffee beans from entering the receiving space from the coffee bean container. The inlet opening can be arranged directly on the coffee bean container or on the container holder. It may be advantageous if the inlet opening together with the closing device is arranged directly on the coffee bean container. When the closing device is closed, the coffee bean container can be removed from the container holder without further coffee beans falling out of the coffee bean container towards the grinder, or generally into the coffee machine.

The closing device can open the inlet opening (i.e., the opening through which coffee beans are fed from the coffee bean container into the coffee machine, i.e., the grinder or a feeder to the grinder) completely or only partially. I.e., the opening cross-section of the inlet opening is adjustable. The size of the opening cross-section can also influence the quantity of coffee beans fed in.

Generally speaking, the actuator in interaction with the closing device allows to adjust the amount of coffee beans supplied per time. In addition to the time the closing device is in the open position, the size of the opening cross-section of the inlet opening can also be varied to determine the amount of coffee beans for the preparation of a coffee drink.

The coffee machine has a detection device that detects and reads an identification of the coffee bean container inserted into the container holder.

The identification can be a contactless readable element, for example an RFID chip. Alternatively, the identification can be an element that is read via one or more contact pins between the coffee bean container and the coffee machine. The identification contains, for example, identification data that enable the coffee machine to read out an identifier of the coffee bean container that has been inserted. Alternatively or additionally, other values can also be read from the identification.

The coffee machine, for example a controller or a control unit of the coffee machine, can then be set based on the read-out identification or with the help of the read-out values. For this purpose, for example, a value for the open time of the closing device for the preparation of a coffee drink can be stored in the identification. Alternatively, the coffee machine can contain a memory which contains the values for setting the coffee machine for a specific identification value of a coffee bean container, for example a so-called look-up table.

The operation of the coffee bean container identification and the reading of the identification is described here, for example, with reference to the open time of the closing device. The same principle can be applied to several other parameters of the coffee machine. Some of these parameters can be: grinding degree of the grinder, water pressure, water temperature, pressure curve, without being limited to these parameters. The coffee bean container identification is used to adjust the coffee machine to the coffee beans contained in a coffee bean container.

In one embodiment, the container holder encloses a receiving space for coffee beans, and the actuator is further arranged to act on the container holder to change a size of the receiving space. The actuator is further configured, when the receiving space is filled with coffee beans, to place the closing device in the closed state and to feed the coffee beans from the receiving space to the grinder.

Generally speaking, the size of the receiving space is a measure of the quantity of coffee beans used in a grinding process. The time period after which the closing device is moved from the open state to the closed state is also a measure of the quantity of coffee beans used in a grinding process. The mechanism of the variable size receiving space and the adjustable time period in which the closing device is held in the open state may alternatively and independently be implemented in a coffee machine described herein.

The receiving space is located in the direction of flow of the coffee beans in the direction of the grinder downstream of the closing device. The opening and closing of the closing device controls when coffee beans are fed into the receiving space.

By changing the size of the receiving space of the container holder, it is possible to determine how many coffee beans are released from the coffee bean container and used for the production of one service of coffee. By changing the size of the receiving space of the container holder, it is not necessary to close the closing device after a certain run-in time to prevent too many coffee beans from entering the receiving space. Rather, the receiving space is adjusted accordingly and then completely filled with coffee beans. An intrusion of coffee beans into the receiving space is thus automatically stopped when the receiving space is filled. Now the closing device is brought into the closed state and the coffee is ground in the correct portion. Further coffee beans can now no longer flow out of the coffee bean container.

This design has another advantage. Several coffee bean containers with different coffee beans can be used with the same coffee machine. After a portion of coffee has been prepared, the closing device of the container holder is in the closed state, and there are no more coffee beans in the receiving space. The coffee bean container can now be detached from the coffee bean container receiving arrangement and another coffee bean container can be applied. Now that there are no beans from the previous operation in the coffee machine, a new operation can be started for making a portion of coffee with a different type of bean.

In a coffee machine with grinder, which freshly grinds the ground coffee for a portion of coffee as needed, it is generally not possible or customary to change the coffee beans as long as there are still beans in a bean container. Changing to a different coffee bean type is thus limited to the time when the bean container has been emptied. This problem is solved in that only as many coffee beans as are needed to prepare a portion of coffee are discharged from the coffee bean container into the receiving space. The coffee bean container is then separated from the receiving space by the closing device. The coffee bean container can be detached from the coffee bean container receiving arrangement, closing the outlet opening of the coffee bean container, and another coffee bean container with a different type of coffee beans can be used. After another coffee bean container is inserted into the coffee bean container receiving arrangement, the size of the receiving space for coffee beans can be changed to use the appropriate amount of coffee beans for the desired coffee flavor or considering the characteristics of the coffee beans.

In other words, the function of the coffee machine can be described as follows: the coffee machine is designed for the preparation of coffee drinks based on freshly ground coffee; the container holder with variable receiving space holds the appropriate amount of coffee beans for one serving of coffee at a time and further coffee beans are prevented from entering the receiving space; after preparation of one serving of coffee, the same coffee bean type can be used for another serving of coffee or the coffee bean container can be exchanged to prepare a coffee with a different flavor. A coffee drink can thus be prepared freshly and the same coffee machine can be operated alternately with different coffee bean types without mixing beans of different types in a significant ratio (apart from, for example, minor residues from previous operations in the grinder or other components of the coffee machine, which have no discernible influence on the coffee taste). The grinder is designed in such a way that usually no whole beans remain in the grinder after making a coffee drink.

The receiving space is defined or limited by the outer wall of the container holder (lateral boundary), by a part of the coffee machine (lower boundary) and by the closing device (upper boundary). The closing device is connected to the container holder.

When the actuator has transferred the closing device to the closed state, the coffee beans can be ground. Either the coffee beans are fed to the grinder separately or the coffee beans lie on the grinder and the grinder is simply activated.

The actuator can also be connected to the grinder in order to adjust the grinding degree of the ground coffee by adjusting the grinding disks. For example, a distance between the grinding discs of the grinder is changed. Grinding can be performed by means of conventional disc or cone grinders. Other designs are possible, e.g., a roller grinder or a rotary piston grinder, in which the ground coffee is ground between the outer housing and an asynchronously rotating inner piston, whereby the asynchronously rotating piston can implement several grinding stages in one revolution.

Nozzles for wetting the coffee beans with liquid can be arranged in the outlet volume. This can reduce or even avoid static charges during the grinding process. In addition, liquids can be used at this stage before the grinding process to influence the flavor profile.

The coffee bean container may be configured in a particular manner for use with the coffee machine described herein. For example, the coffee bean container has an outlet with a closure that is opened when the coffee bean container is coupled to the coffee bean container receiving arrangement and that is automatically closed when the coffee bean container is released from the coffee bean container receiving arrangement. This keeps the beans in the coffee bean container fresh for a long period of time and prevents excessive reaction with the ambient air.

Further properties and features of the coffee bean container are presented and explained in the course of this description.

According to one embodiment, the actuator is arranged and configured to move the container holder translationally with respect to the housing of the coffee machine to change the size of the receiving space. Alternatively or additionally, the actuator is arranged to move a shell surface of the container holder to change the size of the receiving space.

The actuator can be, for example, an electric motor, stepper motor, servomotor, which moves the container holder in or out with respect to the housing of the coffee machine, thereby changing the receiving space, i.e., the interior space of the container holder. Thus, the amount of coffee beans that can be accommodated in the receiving space can be varied. This movement of the container holder can, for example, also entrain the coffee bean container. Based on the above mentioned boundaries of the receiving space by the coffee machine, the lateral wall of the container holder and the closing device, the size of the receiving space in this example is varied in that the upper boundary of the receiving space (the container holder together with the closing device) moves with respect to the coffee machine, thus changing the size of the receiving space.

Alternatively or in addition to this translational movement, a shell surface of the container holder can be manipulated, for example by an unwinding movement or a winding movement, to adjust the circumference of the container holder and thus the receiving space.

The container holder can be cylindrical or sectionally funnel-shaped. In a funnel shape, a change in the diameter of one opening (the smaller opening, the larger opening, or both openings) can be made to change the size of the receiving space. A cylindrical container holder can be moved along its central axis to change the length of the cylinder, which also changes the size of the receiving space.

It is conceivable that the container holder is only moved translationally in order to change the size of the receiving space. The change in the shape or geometry of the shell surface of the container holder can be made in addition to or as an alternative to the translatory movement.

For example, the actuator is connected to the container holder via at least one mechanical coupling element (pressure or traction elements such as a linkage or ropes, etc.) and/or a gear so that a movement of the actuator can be transmitted to the container holder and/or the shell surface of the container holder.

According to a further embodiment, the coffee machine further may include a receiving cup, the receiving cup being movably connected to the container holder so that the receiving cup and the container holder can be moved relative to each other, and the receiving space for coffee beans is defined by the receiving cup, the container holder, and the closing device when in the closed state.

The container holder and the receiving cup are telescopically interlocked, for example. Thus, the container holder can be moved translationally with respect to the receiving cup and thereby change the receiving space. When the coffee beans have entered the receiving space, the closing device is closed so that no further coffee beans can flow out of the coffee bean container and an outlet opening of the receiving cup is opened to guide the coffee beans out of the receiving space to the grinder.

The receiving cup is optional and not mandatory to determine the amount of coffee beans. If the dead spaces in the grinder and the volume of the container holder below the closing device are known, then the receiving space can also be determined from the shape and/or position of the container holder, because the beans flowing into the receiving space are initially accumulated below by the grinding disks of the grinder.

According to a further embodiment, the coffee machine further may include a strainer and a tamper, and the strainer is arranged to collect ground coffee from the grinder and the tamper is arranged to apply a compressive force to the ground coffee in the strainer and to cause a homogeneous surface, distribution and thickness of the ground coffee in the strainer.

The strainer can be arranged below the grinder so that the ground coffee falls directly into the strainer after grinding and is collected therein. Following the grinding process, the ground coffee is evenly distributed in the strainer by means of the tamper.

The tamper may contain a plunger or a plate and is pressed onto the ground coffee in the strainer with a predetermined force. During the grinding process, the tamper is stowed in a parking position in the housing of the coffee machine. After the grinding process, the tamper is extended from the parking position and brought over the strainer. Now the tamper can be placed on the ground coffee in the strainer with a predefined force.

The coffee machine can have an actuator that causes the movements of the tamper.

The function of the tamper can alternatively also be fulfilled with an impeller. The impeller is located between the grinder and the sieve and rotates during the grinding process. This rotation distributes the ground coffee in the strainer. After the grinding process, the impeller is moved in the direction of the strainer and sits on the ground coffee, distributing it evenly in the strainer.

It is also conceivable that the ground coffee is mixed and evenly distributed by air turbulence after the grinding process and during falling. To achieve this, however, vibrations can also be applied to the strainer as an alternative or in addition.

According to a further embodiment, the coffee machine is designed to be operated selectively with one coffee bean container of a plurality of exchangeable coffee bean containers.

Basically, a coffee bean container placed in the container holder is in the closed state, i.e., no coffee beans fall into the grinder or the coffee machine. Coffee beans are released from the coffee bean container by opening the closing device only when required. The quantity of coffee beans released is then used to prepare a coffee drink. This means that no coffee beans remain in the grinder or in the feed to the grinder. Between the preparation of two coffee drinks, the coffee bean container can be changed, and the newly inserted coffee bean container can contain different coffee beans (different types, different degree of roasting, generally beans with a different odor and taste profile). However, it is ensured that the beans from different coffee bean containers do not mix in the coffee machine.

Referring to the detection device described above, this can be an optical detection unit (e.g., a scanner) or a radio wave receiver (e.g., a so-called NFC or RFID receiver). The detection device detects either an optical identification of the coffee bean container or an electromagnetic identifier and, depending on the identifier, sets the coffee machine parameters, e.g., the time duration of the open state of the closing device or the size of the receiving space, for the coffee beans from the respective coffee bean container. If the coffee bean container is changed, the coffee machine adjusts to the new coffee bean container.

For example, the detection device can read only one coffee bean container identifier and set the coffee machine parameters (size of the receiving space, flow profile of the water, temperature of the water, water pressure, etc., see also the description below) depending on this identifier, for example based on a table of setting values.

The coffee bean container identifier may be, for example, a number, an alphanumeric string, or any other string that uniquely identifies a coffee bean container or the coffee beans contained in the coffee bean container to enable the coffee machine to apply the coffee machine parameter setting intended for those coffee beans.

Alternatively, the coffee machine can be designed to read in a set of parameters for setting the coffee machine via the detection device. This second approach has the advantage that a separate table with setting values does not have to be kept available and that the setting values of the coffee machine can be specified completely anew with each coffee bean container, regardless of whether the existing table with setting values has an entry for a specific coffee bean container.

According to a further embodiment, the coffee machine further may include a water reservoir, the water reservoir comprising a housing and a piston movable therein, the piston being drivable by an actuator to move within the housing and, upon or through such movement, to force a fluid therein out of the housing through an outlet opening.

The water reservoir may be designed to hold water for a single brew or portion of coffee drink. The actuator moves the piston in the water reservoir and pushes the water from the housing through the ground coffee in the strainer. Thereby the coffee drink is prepared. The actuator can cause a predetermined movement profile or flow profile of the water. For example, the flow rate per time can be specified in detail and the actuator moves the piston to achieve this flow rate.

The housing can also have a water inlet for refilling the water reservoir with water after a coffee drink production process.

The piston can be driven electromechanically or hydraulically. The flow rate and the flow volume of the water through the ground coffee can be specified via the path of the piston or its movement over time. The movement or position of the piston can be sensed by one or more sensors, which can be located on the piston or on the actuator. The water pressure can be determined from the mechanical load of the piston, for which a sensor can also be used. The mechanical load of the piston can be used as a manipulated variable for the pressure-flow profile, as described below.

According to a further embodiment, the coffee machine further may include at least one heating element arranged at the water reservoir and configured to heat the fluid in the water reservoir to a predetermined temperature.

The heating element is in particular an electrical heating element and is arranged, for example, on the walls of the housing. The heating element can also be arranged in the water reservoir, but care must be taken that the heating element does not impede the movement of the piston.

According to a further embodiment, the coffee machine further may include a first sensor and/or a second sensor, and the first sensor is configured to detect a flow profile of the fluid at the outlet opening of the housing of the water reservoir, and the second sensor is configured to detect a force applied by the actuator to the piston.

The flow profile of the fluid forced out of the water reservoir allows conclusions to be drawn about how the fluid flows through the ground coffee in the strainer. The coffee machine has a closed fluid circuit, so that this conclusion is readily permissible. In any case, this flow profile detected by the first sensor can be compared with an expected flow profile. If the sensed flow profile deviates from the expected flow profile, a control unit can vary the actuator and the force applied to the fluid to arrive at a target flow profile of the fluid through the ground coffee. The reason for monitoring the flow profile of the fluid is that the flow profile of water through the ground coffee also affects the taste of the coffee drink. Thus, the taste of the coffee drink can be improved if the appropriate flow profile (corresponding in particular to the flow rate over time) is set.

The second sensor monitors the force applied to the piston, which in turn corresponds to the water pressure. The values detected by this sensor can also be compared with a setpoint and the actuator can be controlled accordingly so that the water pressure corresponds to a pre-settable setpoint (which can be different for each type of coffee bean or for each coffee drink).

The coffee machine has a control unit that is connected to the sensors and the detection device and can receive data from these sensors. Based on the data received from the sensors and the detection device for coffee bean containers, the control unit sends commands to the actuator to set the size of the receiving space (or the time period after which the closing device is moved from the open state to the closed state, i.e., in general terms, to set the amount of coffee beans or ground coffee for a single coffee drink preparation process), to the grinder to set the grind level for the coffee beans, to the water reservoir to set the temperature, the flow profile, and the water pressure.

The parameters described herein can also be referred to as preparation parameters. The preparation parameters include, on the one hand, so-called brew parameters, which refer to the immediate brewing process of the coffee drink, and, on the other hand, the quantity and degree of grinding of the ground coffee. For example, the amount of ground coffee used refers to its weight, regardless of how this weight is adjusted, e.g., by the size of the receiving space for coffee beans before the grinding process or the weight of the beans or the period of time the closing device is open. The brew parameters refer to the temperature of the water or a temperature curve, the flow profile of the water (amount of water per time), and a pressure profile of the water (pressure curve over time) during the brewing process.

In other words, the coffee machine is parameterized and set based on the identification of the coffee bean container. Manual adjustment of the coffee machine is no longer necessary, because the coffee machine is automatically adjusted to the parameters determined by the manufacturer or supplier of the coffee beans and recorded in the identification of the coffee bean container. A consistent taste and optimum extraction level (as the proportion of dissolved substances from the coffee bean) of the coffee drink produced in this way can thus be achieved.

The control unit of the coffee machine can measure the brew parameters mentioned and record them for each individual preparation process. It may be that certain brew parameters deviate from the specification during the preparation process. If the actual prevailing brew parameters are measured (using the sensors referred to herein), a deviation from the predetermined brew parameters may be detected. For example, it may be the case that a flow profile and a pressure profile of the water deviate from the default. This may indicate that the water pressure is too high, which may result in a lower quality coffee drink as it affects the extraction of flavor.

The control unit can be designed to compare the measured brew parameters with the predefined brew parameters (as specified by the identification element on the coffee bean container). In case of a deviation between measurement and default by a predetermined threshold value, the control unit can apply a correction value to the default in order to adjust the brew parameters. Such an adjustment can also be made when a user initiates an adjustment by an input at the coffee machine.

In one embodiment, the coffee machine may be configured to record a pressure profile of the water during the brewing process according to a recipe. The recipe specifies, for example, a flow rate (amount of water per time). An expected pressure profile for the time during the brewing process is stored for this recipe and the specified flow rate. If the recorded pressure profile deviates from the expected pressure profile, this may indicate a need for adjustment of the specified brew parameters. In the example given here, the flow rate according to the recipe could then be increased or decreased. This adjustment can be made by the control unit of a coffee machine if the control unit detects a deviation between the recorded and expected values.

In a recipe, for example, the flow rate can be specified and the pressure profile is measured and compared with an expected pressure profile. However, it is also conceivable that in a recipe the pressure profile is predetermined and the flow rate is measured and compared with an expected flow rate. The expected pressure profile or the expected flow rate from a recipe are, for example, predetermined values based on experience or based on taste sensory feedback. The expected pressure profile or flow rate are sized to correspond to a high quality coffee drink.

In one embodiment, the control unit may be designed to vary the brew parameters depending on the measured pressure profile and/or flow profile.

In one embodiment, the control unit may be configured to vary the brew parameters depending on coffee bean characteristics.

The coffee bean properties in this sense include, for example, the origin, the roasting temperature and/or flavor attributes, which are stored on the identification element. The identification element can, for example, contain identification values for the respective coffee bean properties.

The coffee machine can have an input/output unit or an operating element that enables a person to interact with the coffee machine and influence the brew parameters, among other things. The operating element can, for example, be attached to a housing of the coffee machine and be designed as a display with an input function. For example, inputs can be made via switches, buttons or rotary knobs. Alternatively, the display can be designed as a touch-sensitive display via which a person can make direct inputs.

In this way, the quality of the coffee drink can be improved by training the control unit on the brew parameters and user inputs. For this purpose, the control unit uses data collected by the machine for each brewing process (the above-mentioned brew parameters, in particular the flow and pressure profiles, but possibly also the water quantity and/or temperature profiles, and optionally also the other preparation parameters such as degree of grind and coffee powder quantity). Preferably, at least the maximum brewing pressure and/or the pressure and flow rate curve (flow and pressure profiles) of the measured preparation process are used as parameters for evaluating a preparation process. In addition, the temperature curve can be determined and used. The data of the preparation process are used to readjust the initial parameters and to achieve an optimal preparation process in terms of pressure and flow curves. If, in addition, the bean properties (such as place of origin and roasting temperature, etc.) are linked to the measured brew parameters, new beans can be automatically adjusted to the best parameters by the control unit, for example by using the brew parameters of those beans whose bean properties most closely match the new beans.

The sensor data determined by the machine serve as the basis for training the control unit. The control unit can be designed to output predictions of the flavor profiles of the brewed coffee based on the growing conditions, growing region and planned processing of the coffee beans. Feedback from the user about the taste of the coffee can be used to link the bean characteristics to specific taste sensory characteristics. An algorithm trained on this data can make a prediction about the taste of the coffee based only on the bean characteristics (growing region, roasting temperature, etc.). Input parameters for this function are at least one bean property (which can be read from the identification of the coffee bean container) and the necessary measurement parameter is the user input about the taste sensory perception.

The control unit can adapt existing recipes (i.e., the preparation parameters) to a desired taste of a user. The control unit can also make a prediction or recommendation of coffee beans or their origin or processing, based on a taste profile of the user. For this purpose, the control unit compares the input about the taste sensory perception of the user with the bean characteristics of the beans used and estimates in which direction the user has changed the taste by the input. Through this estimation, the control unit can determine which beans have an appropriate flavor profile and then recommend those beans for consumption. Following a similar mechanism, the control unit can recommend beans of a particular growing region or processing.

According to another aspect, an arrangement comprising a plurality of coffee machines described herein is disclosed. The plurality of coffee machines are communicatively connected to a central unit such that the coffee machines can transmit data to or receive data from the central unit. For example, the coffee machines are connected to the central unit via a data network or data link.

A memory with recipes can be kept in the central unit, with the recipes each containing the preparation parameters for a specific type of bean. In this way, it is possible to supply the coffee machines centrally with the recipes.

Conversely, it is also possible for the coffee machines to transmit the measured values recorded by the sensors and belonging to a specific bean type (in particular the brew parameters) to the central unit. In this way, the central unit can evaluate whether or not the specified brew parameters match the specific bean type. If it is determined that the specified brew parameters cause an undesirable behavior (an unsuitable flow profile or an unsuitable pressure curve), the recipe for the specific bean type can be changed and distributed to the coffee machines.

The central unit can adjust the brew parameters in the same way as the local control unit, whereby the central unit uses measured values from a plurality of coffee machines. The measured values recorded by the sensors of the multiple coffee machines are transmitted to the central unit. In the central unit, the recorded measured values are then compared with the expected values for the respective parameter as assigned to a recipe (pressure profile of the water or flow rate of the water). If there is a discrepancy between the measured values and the expected values, the corresponding recipe can be adjusted in the central unit and communicated to the coffee machines, so that with the adjusted recipe the measured values correspond to the expected values. The basic idea here is that the control unit in the coffee machines regulates a manipulated variable as specified in the recipe (for example, the flow rate of the water in a first case or the pressure profile of the water in a second case) and that sensors in the coffee machines measure a test variable (for example, the pressure profile of the water in the first case or the flow rate of the water in the second case). The measured test variable is compared to an expected value for the test variable, and if there is a discrepancy, the recipe and its default manipulated variable are adjusted. This process may be implemented locally in each coffee machine using the locally measured values or the process may be implemented in the central unit using the measured values of a plurality of coffee machines.

According to another aspect, a coffee bean container is disclosed. The coffee bean container may include a housing, an outlet and an identification element. The housing is configured to receive coffee beans. The outlet is arranged to discharge coffee beans from the housing. The identification element is machine readable and contains an instruction for setting parameters of a coffee machine for preparing a coffee drink with the coffee beans from the housing. The identification element is configured to preset a first parameter of the coffee machine, and the first parameter is configured to instruct an actuator to move a closing device on a container holder of the coffee machine or on the coffee bean container from an open state to a closed state and vice versa and to move the closing device from the open state to the closed state after an adjustable period of time, thereby presetting a quantity of coffee beans to be fed to the grinder.

The coffee bean container is configured to interact with the coffee machine described herein. The identification element is optically or electromagnetically readable as described in connection with the coffee machine. The coffee bean container thus includes a prescription for setting the coffee machine to produce a coffee drink with the coffee beans contained therein.

The identification element can be a character string, as described above, which acts as an identifier and enables the coffee machine to apply the setting parameters assigned to this character string. Alternatively, the identification element can contain the setting parameters.

The outlet of the coffee bean container is configured to be coupled to the coffee bean container receiving arrangement or the container holder of the coffee machine.

According to a further embodiment, the coffee bean container further may include a locking element arranged to releasably lock the outlet to a container holder of a coffee machine.

The locking element can be designed as a pin, hook, or eye, for example. The locking element interacts with a counterpart on the container holder and serves to lock the coffee bean container to the container holder of the coffee machine. This locking can be made and released without tools, for example by placing the coffee bean container on the container holder in such a way that the locking element engages in a locking groove of the container holder. From this position, the coffee bean container can be rotated or locked into a locked position.

According to a further embodiment, the coffee bean container further may include a closure, and the closure is arranged to selectively open or close the outlet of the coffee bean container, and the closure is arranged to transition from a closed state to an open state when the coffee bean container is connected to a container holder of a coffee machine.

When the coffee bean container is not inserted in the coffee machine, the closure closes the housing and protects the coffee beans contained therein. When the coffee bean container is inserted into the coffee machine, the closure is moved to the open position and allows the coffee beans to enter the receiving space of the container holder when its closing device is also in the open state. When the coffee bean container is removed from the container holder, the closure of the coffee bean container is placed in the closed state. The closure can be designed, for example, as a central closure or lamella closure, in which closure plates are pushed radially in front of the outlet opening of the coffee bean container and thus close it. When the coffee bean container is inserted into the container holder of the coffee machine, the outlet opening of the coffee bean container is released by the closure opening during this insertion movement. In this state, no coffee beans enter the receiving space. After the coffee bean container has been inserted into the container holder, the coffee machine recognizes this and reads the identification of the coffee bean container. The coffee machine is then set according to the transferred parameters. Now, a coffee drink can be prepared. First, the closing device of the container holder opens, lets coffee beans into the receiving space, closes the receiving space with the locking device and then prepares the coffee drink as described above. Now, the coffee bean container can be changed (causing a new coffee machine setting procedure; in general, the parameters are applied to the coffee machine when a coffee bean container is inserted into the container holder) or another coffee drink can be prepared with the same coffee bean container.

According to a further aspect, a system for preparing coffee drinks is disclosed. The system may include one or more coffee bean containers as described herein and a coffee machine as described herein.

The system enables the coffee machine to be used for the fresh preparation of coffee drinks based on freshly ground coffee beans with several different coffee bean containers (and different coffee beans or types of coffee beans contained therein), whereby the coffee bean containers can be inserted selectively, and the coffee machine parameterizes itself depending on the parameterization specifications on the identification element of the coffee bean container.

In general, it is conceivable in connection with the coffee machine and the system that a user of the coffee machine deviates from the predefined parameters for setting the coffee machine. Although the coffee machine sets these parameters, a user may permanently or temporarily change the predetermined parameters for a particular type of coffee and thus, for example, train (parameterize) for a new type of coffee bean. For this purpose, the coffee machine may include a data memory that stores the user-specific parameterization for a particular identifier of a coffee bean container. When the coffee machine reads this identifier from the identification element, the parameters from the data memory can then be applied directly. For this purpose, this data memory can optionally be arranged in a decentralized manner, in which case the data memory can be accessed via a data network. Such a central data memory can be updated from a central location, for example by centrally adjusting the parameters to a particular coffee bean variety, for example by changing existing parameters to a coffee bean variety or offering a parameter set to a new coffee bean variety. The central data memory can be contacted and read out each time the coffee machine parameters are adjusted, in order to apply the read-out parameters to the respective coffee machine in a decentralized manner, or the data memory can serve as a source for distributing updated parameters to the coffee machines, so that the parameters are kept in the coffee machines in a decentralized manner after the update process.

Furthermore, the coffee bean container can be hermetically sealed with the container holder so that the coffee beans are kept in as inert an atmosphere as possible when the coffee bean container is inserted into the container holder. Of course, the coffee bean container can be detached from the container holder after each preparation of a coffee drink, whereby the closure closes the outlet opening of the coffee bean container and thus protects the coffee beans.

Several such systems can be connected to each other via a data network (e.g., via the Internet or a private data network) and transmit information about the coffee machines' parameters to a central data repository. This allows alternative parameters for a coffee bean type to be transmitted, allowing other users to use the same parameter set.

In the following, a coffee machine or parts thereof are described according to further aspects. Each aspect includes several variants, and references from one variant to another variant are to be understood as referring to variants of the same aspect.

Aspect 2—Strainer for Coffee Machine and Coffee Machine with Strainer

Aspect 2, initial variant (variant 0): a strainer for a coffee machine, for example a so-called portafilter machine, the strainer comprising a first coating arranged to provide thermal insulation between the strainer and a strainer support of the coffee machine.

The coffee machine according to aspect 2, initial variant may be a coffee machine as described herein. However, the coffee machine may also be a machine that does not have, or only partially has, the other features described herein. In other words, such a strainer may be used in any portafilter machine for preparing hot beverages, such as coffee drinks. For example, the grinder, the closing device on the container holder or the coffee bean container along with associated actuator, and the coffee bean container receiving arrangement and the coffee bean container may be omitted for the functions described in aspect 2. In aspect 2, the detection device can also be omitted.

The strainer support is an element that holds or supports the strainer in its predetermined position.

Aspect 2, Variant 1: the strainer according to the initial variant, in which the first coating is disposed on an outer surface of the strainer.

A strainer can be described in general terms as a container and has, for example, a substantially U-shaped profile. This container has a base area and an interior space as well as lateral walls. In the base area there are openings which allow the function of a strainer. In the case of coffee drink preparation, the strainer contains ground coffee through which hot water is forced. The water absorbs substances from the ground coffee and flows through the openings in the base area of the strainer into a vessel.

Aspect 2, Variant 2: the strainer according to the initial variant or Variant 1, in which the first coating covers or overlies a portion or all of the outer surface of the strainer.

The strainer is usually held by a support. The support can also be referred to as the strainer support. The first coating may be arranged on the strainer in such a way that the transfer of thermal energy from the strainer to the support is reduced.

It is conceivable that the first coating is arranged on the strainer in such a way that the first coating on the outer surface is only arranged at those points or surfaces where the strainer is in contact (i.e., in mechanical contact) with the support. Then the first coating ensures that the flow of thermal energy (i.e., thermal conduction) between the strainer and the support is reduced at precisely these points. Alternatively, the entire outer surface of the strainer can be coated with the thermally insulating first coating.

The outer surface of the strainer is in particular that surface which runs along one or more lateral walls and/or a shoulder of the strainer and faces away from the interior space of the strainer. The outer surface of the lateral walls and/or a shoulder, which holds the strainer on the support, are usually in mechanical contact with the support at least in sections. The thermally insulating first coating at these positions ensures that the outflow of thermal energy from the strainer to the support is reduced.

In one variant, the strainer can also have a thermally insulating coating on the entire outer surface, i.e., also where the outer surface of the strainer is not in mechanical contact with the support or another element of the coffee machine. By thermally insulating the strainer also on those sections of the outer surface that are only in contact with the ambient air, a loss of thermal energy through convection can also be reduced. For example, the base area of the strainer on the side facing away from the interior space can also be coated with the first coating.

The first coating on the entire or partial outer surface of the strainer helps to reduce the dissipation of thermal energy from the strainer. It is also conceivable that a ceramic coating is applied to an interior surface of the strainer, such as to the entire interior surface.

The strainer may, for example, consist of a metallic base material provided with the first coating.

This has the advantage of improving the energy efficiency of the coffee machine without negatively affecting the quality of the prepared beverage. An important point for the quality of prepared coffee drinks is, among other things, the temperature stability of the water during the preparation of the coffee drink, especially while the water is in contact with the ground coffee. This temperature stability can be realized on the one hand by a high thermal mass of the strainer and the support in contact with it, which are preheated to an appropriate temperature and kept at this temperature. In order to reduce the energy required for heating the strainer and the support, it is proposed in this aspect that the strainer is thermally isolated from the support to reduce the energy required while still maintaining a constant brewing temperature of the water. This thermal insulation can be realized, for example, by a ceramic first coating of the strainer. The insulation reduces the thermal mass, which should have a constant temperature, to that of the strainer. The support is thermally separated or isolated from the strainer.

Aspect 2, Variant 3: the strainer according to any of the previous variants of aspect 2, in which the first coating is a ceramic coating.

Ceramic is an inorganic non-metallic material and has low thermal conductivity combined with high mechanical strength. For example, aluminum oxide (Al₂O₃) can be used.

The thickness of the first coating can be varied depending on the application and expected temperature differences between the strainer and the support. For example, the first coating can be a few tenths of a millimeter up to one millimeter thick.

Aspect 2, Variant 4: The strainer according to any of the preceding variants of aspect 2, further comprising a second coating, in which the second coating covers or overlays a portion or all of an interior surface of the screen.

The second coating may have non-stick properties. This has the advantage that the ground coffee does not adhere to the strainer or its interior surface after preparation of a coffee drink or detaches more easily therefrom. The second coating may contain or consist of a fluoropolymer, for example polytetrafluoroethylene (PTFE). However, the second coating can also be based on ceramics (i.e., contain or consist of ceramics) and have a smooth surface, which also provides good anti-adhesion properties.

Aspect 2, Variant 5: a coffee machine having a strainer support and having a strainer according to any of the previous variants of Aspect 2.

The strainer is detachable from the strainer support. When the strainer is removed from the strainer support, the interior space of the strainer can be filled with ground coffee. After the ground coffee has been prepared for the preparation of a coffee drink, the strainer is inserted into the strainer support and the preparation process is started. For the purpose of this variant, strainer support means any holder for holding the strainer during a preparation process of a coffee drink or other hot beverage.

Aspect 2, Variant 6: The coffee machine of Variant 5, in which a holding surface of the strainer support may include a thermally insulating coating.

This thermally insulating coating can be of the same type as the coating on the outer surface of the strainer. The strainer support may be coated with the first coating on those surfaces that are in mechanical contact with the strainer. The strainer can contact the strainer support in the inserted state at one or more surfaces or punctually at several points. At these contact points or contact surfaces, the strainer and optionally the strainer support is coated with the thermally insulating first coating. The first coating on the strainer and optionally on the strainer support reduces the thermal flow from the strainer to the strainer support.

Aspect 3—Networked Intelligent Coffee Machine

Aspect 3, initial variant (variant 0): a coffee machine with a control unit and at least one sensor, in which the sensor is configured to detect a brew parameter during the preparation of a coffee drink and to transmit it to the control unit, and the control unit is configured to modify a recipe for the preparation of a coffee drink based on the detected brew parameter.

With regard to the function of the control unit and the at least one sensor as well as the definition of the brew parameters, reference is made to the above description, in particular to the explanations regarding the manipulated variable and the test variable as well as to the adaptation of the recipe in case of deviations between a value of the measured test variable and a value of the expected test variable. The coffee machine may comprise more than one sensor. The control unit is designed to modify the parameters contained in the recipe for the preparation of a coffee drink based on the detected brew parameters (for example flow profile, pressure curve, etc.) if the detected brew parameters indicate a lower quality of the coffee drink.

Aspect 3, Variant 1: the coffee machine according to the initial variant, the coffee machine may include an input/output unit configured to receive an input from a user.

The user's input concerns, for example, taste sensory parameters of a prepared coffee drink. The taste sensory parameters are transmitted to the control unit. The control unit is designed to use the taste sensory parameters to vary the brew parameters of a recipe.

Aspect 3, Variant 2: The coffee machine according to any one of the previous variants, further comprising an interface for establishing a connection to a data network, and the coffee machine is adapted to be communicatively connected to a central unit such that the coffee machine can send data to and/or receive data from the central unit.

For example, the interface can be designed to establish a wireless connection (e.g., WiFi, IEEE 802.11 protocol family) to an access point of a data network. However, the interface can also be designed for a wired connection (Ethernet or other standards). The coffee machine is usually connected indirectly to the central unit via this interface, i.e., the connection between the coffee machine and the central unit is established via an intermediate data network.

For the variants of aspect 3, reference is made to the corresponding description elsewhere in this document with respect to the sensors and the brew parameters. The brew parameters specified in a recipe and the brew parameters measured by the sensors are also used in aspect 3 as they are reproduced elsewhere in this description.

Aspect 3, Variant 3: an arrangement comprising a plurality of coffee machines according to any one of the preceding variants and at least one central unit, in which each one of the plurality of coffee machines is connected to a central unit such that data can be exchanged between the respective coffee machine and the central unit in at least one direction.

It is conceivable that some coffee machines only send data in the direction of the central unit, but do not receive any data. Conversely, it is also conceivable that some coffee machines do not send any data in the direction of the central unit, but only receive or retrieve data from the central unit. The data exchange between the coffee machine and the central unit can, for example, be a setting option specified by a user of the coffee machine. The data exchange between a coffee machine and the central unit can be based on a so-called push or pull mechanism, i.e., the data sink retrieves data (pull) or the data source sends data on its own (push).

The input device of a coffee machine can be designed in such a way that a user can order accessories or coffee beans by means of the input device via a predefined input mask. For this purpose, the coffee machine may suggest to the user a bean type that corresponds to the taste sensory profiles preferred by this user.

In the central unit, the transmitted measured brew parameters can be used to adjust a recipe of a specific bean type. This can be helpful, for example, if it is determined for a recipe that the specified brew parameters lead to an undesirable time curve of the measured brew parameters.

In aspect 3, the coffee machine may be a coffee machine according to any of the other aspects described herein. However, it may also be a coffee machine with a different range of functions. For example, the grinder, the closing device on the container holder or the coffee bean container including the associated actuator, the coffee bean container receiving arrangement and the coffee bean container may be omitted for the functions described in aspect 3. Optionally, the detection device may also be omitted if a recipe with the predetermined brew parameters for the preparation of a coffee drink is selected in another way, for example via the input device.

### BRIEF DESCRIPTION OF THE DRAWINGS

In the following, the attached drawings are used to illustrate examples in more detail. The illustrations are schematic and not to scale. Identical reference signs refer to identical or similar elements. They show:

FIG. 1 a schematic representation of a system for preparing coffee drinks according to one embodiment.

FIG. 2 a schematic representation of a part of a coffee machine according to a further embodiment.

FIG. 3 a schematic representation of a water reservoir of a coffee machine according to a further embodiment.

FIG. 4 a schematic representation of a control unit and two sensors of a coffee machine according to a further embodiment.

FIG. 5 a schematic representation of a coffee machine with a strainer support and a coated strainer.

FIG. 6 a schematic representation of an arrangement of a plurality of coffee machines communicatively connected to a central unit.

### DETAILED DESCRIPTION OF EMBODIMENTS

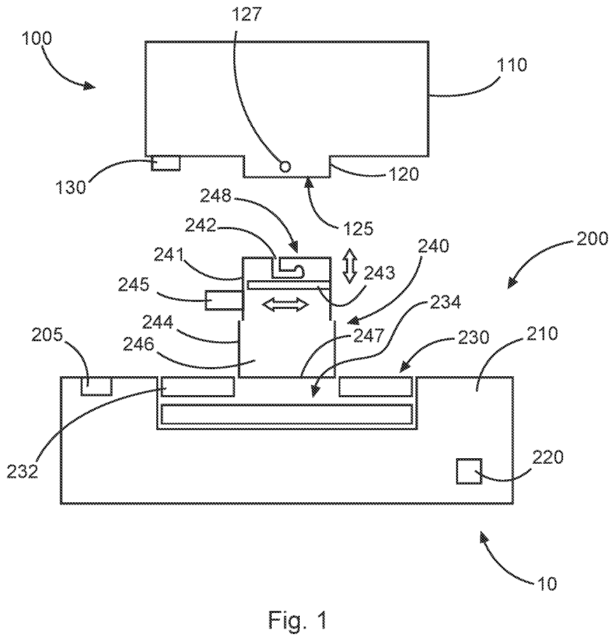

FIG. 1 shows a system 10 comprising a coffee bean container 100 and a coffee machine 200. The coffee bean container 100 may include a housing 110, an outlet 120 with a closure 125 and a locking element 127, and an identification element 130. The coffee machine 200 may include a housing 210, a control unit 220, a grinder 230 and a coffee bean container receiving arrangement 240. Furthermore, the coffee machine 200 may include a detection device 205. In this example, the detection device 205 is arranged at the housing 210. In particular, the detection device 205 is positioned to read the identification element 130 of the coffee bean container 100 when the coffee bean container 100 is coupled to the coffee bean container receiving arrangement 240.

The grinder 230 may include one or more grinding disks 232. Between the grinding disks 232 there is a free space 234 into which the coffee beans are inserted before the grinding process begins. The grinder 230 is adjustable via an actuator, for example via the actuator 245, by varying the distance between the grinding disks 232.

The coffee bean container receiving arrangement 240 includes a container holder 241 and a receiving cup 244. The container holder 241 is movable relative to the receiving cup 244, for example, by the actuator 245 moving the container holder 241 up or down. This movement varies the size of the receiving space 246, which is the interior space of the container holder 241 and receiving cup 244.

The container holder 241 has a locking groove 242. The coffee bean container 100 is placed on the container holder 241 with the outlet 120 so that the locking element 127 engages in the locking groove 242. The coffee bean container 100 is then rotated to a locked position. During this rotational movement, the closure 125 of the outlet 120 is opened so that coffee beans can pass from the coffee bean container 100 into the receiving space 246.

With respect to the coffee bean container 100, it is conceivable that the housing 110 is rotatable with respect to the outlet 120 to open the closure 125 upon this relative movement between the housing 110 and the outlet 120. When the coffee bean container 100 is coupled to the container holder 241, there is first a first rotational movement that locks the locking element 127 in the locking groove 242. Subsequently, the housing 110 of the coffee bean container 100 may be rotated in the same direction, and during this subsequent rotational movement, a portion of the outlet 120 is no longer rotated, such that this second movement opens the closure 125 of the outlet 120. However, the closure 125 can also be opened in other ways, for example by a lever or other opening element arranged on the housing 110. Removing the coffee bean container 100 performs these steps in reverse order: first, the housing 110 is rotated with respect to the outlet 120 to close the outlet 120 with the closure 125, then the locking element 127 in the locking groove 242 is released and the coffee bean container 100 can be removed.

The container holder 241 may include a closing device 243. The closing device 243 opens or closes the access to the receiving space 246. The closing device 243 is actuated by the actuator 245. The receiving space 246 is filled with coffee beans in a quantity that is intended for preparing a portion of a coffee drink. For this purpose, the actuator 245 adjusts the size of the receiving space 246, in the example of FIG. 1 by moving the container holder 241 up or down. Then, the closing device 243 is moved, for example by a lateral sliding movement, and coffee beans enter the receiving space 246. The amount of coffee beans in the receiving space 246 is limited by the receiving space 246 being full. Then, the closing device 243 is moved to the closed position. Subsequently, the coffee beans are fed from the receiving space 246 to the grinder 230, for example, by releasing an outlet opening 247 of the receiving cup 244. The outlet opening 247 can be selectively opened or closed with a closing device (not shown, similar to the closing device 243 at the inlet of the receiving space 246). Since the closing device 243 is in the closed position, no further coffee beans flow through the inlet opening 248 into the receiving space 246 or the grinder 230 and the coffee beans are portioned for this brewing operation as specified. Once all coffee beans have been ground, outlet opening 247 is closed again and the process for making a coffee drink can be repeated.

The receiving cup 244 may also be omitted. Without the receiving cup 244, the receiving space 246 of the container holder 241 is extended by a free space 234 in the grinder 230. When the closing device 243 is opened, coffee beans flow into the receiving space 246 and the free space 234. Provided that the free space 234 and its size are known, the size of the receiving space 246 can be adjusted by moving the container holder 241.

Before the next coffee drink is produced, the coffee bean container 100 can be changed. If a coffee bean container 100 with a different coffee bean type is used, the coffee machine 200 detects the identification element 130 of the new coffee bean container 100 by means of the detection device 205 and sets the coffee machine to the new coffee bean type.

In summary, FIG. 1 describes a coffee machine 200, a coffee bean container 100, and a system 10 comprising a coffee machine 200 and a coffee bean container 100. The coffee bean container 100 includes an identification element 130 that is read by the coffee machine 200 when the coffee bean container 100 is placed on the coffee machine 200. Based on the information read out from the identification element 130, a set of parameters (the so-called preparation parameters) is applied to the coffee machine and the coffee machine is individually set for the placed coffee bean container. Various actuators are provided which can set the following parameters: amount of coffee beans (by setting the size of the receiving space with a corresponding actuator), grinding degree (by setting the grinder), flow profile, pressure, amount of water (by controlling the actuator of the water reservoir), temperature of the water (controlling the heating element on the water reservoir). The settings are applied by the control unit 220 of the coffee machine by transmitting corresponding setting commands from the control unit 220 to the respective actuators or the heating elements.

Although FIG. 1 shows a container holder 241 with a closing device 243, the closing device 243 may also be part of the coffee bean container. The closing device can be a flap or a slider at the outlet opening of the coffee bean container. An actuator of the coffee machine including a lever or linkage may act on the closing device and thereby release said opening of the coffee bean container so that coffee beans fall by gravity from the coffee bean container into the grinder or a feed to the grinder.

The design of the coffee bean container 100 and the coffee machine 200 described here is characterized in particular by the fact that the coffee bean container 100 can be changed after each preparation process of a portion of coffee drink and that no unground coffee beans of the previous coffee bean type are in the grinder. The coffee machine 200 makes it possible to prepare coffee drinks based on freshly ground coffee and still change the coffee bean type after each individual production process of a portion of coffee drink.

The control unit 220 may be a programmed controller connected to the detection device 205 and the actuator 245. The control unit 220 receives information from the detection device 205 about the identification 130 of the coffee bean container 100 and, based on this information, generates control commands that instruct the actuator 245 to adjust the coffee machine 200 accordingly.

The actuator 245 is shown by way of example only. It is to be understood that the coffee machine may include one or more actuators 245, each actuator arranged to set a parameter of the coffee machine or to perform a function. The functions to be performed are: moving the closing device 243 from the open state to the closed state and vice versa; the same function is also implemented for releasing or closing the outlet opening 247; adjusting the grinding degree of the grinder 230; varying the size of the receiving space 246. Further functions are described with reference to the following figures and are mentioned here only for completeness: distributing and compacting ground coffee in a strainer; dispensing water from a water reservoir; heating water in the water reservoir.

The control unit 220 is configured to instruct one or more actuators to execute the above functions according to a specification corresponding to the identification of a coffee bean container to adjust the coffee machine as specified.

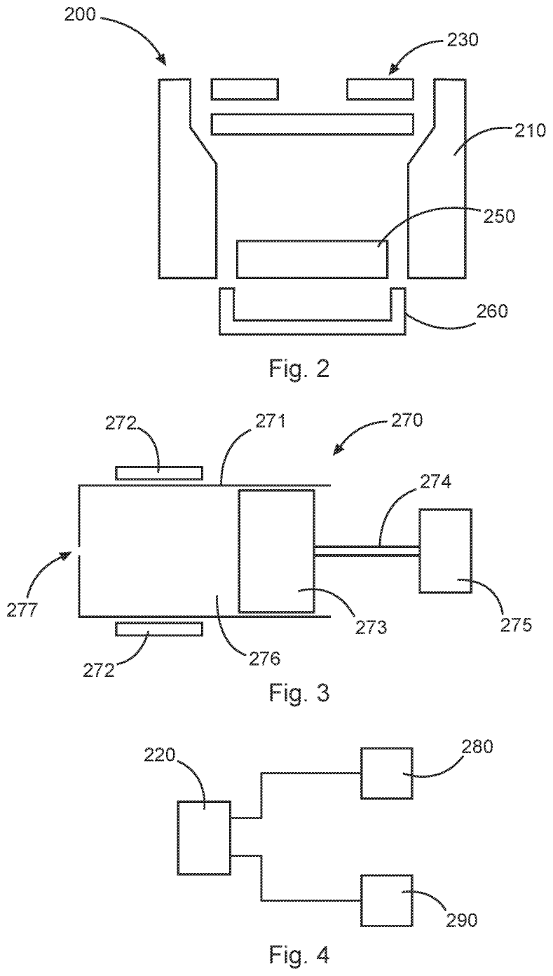

FIG. 2 shows a schematic diagram of the coffee machine 200 with housing 210, grinder 230, tamper 250 and strainer 260. When the coffee beans are ground in the grinder 230, the resulting ground coffee falls onto the strainer 260. In this state, the ground coffee may be unevenly distributed in the strainer. The tamper 250 is now used to evenly distribute and compact the ground coffee in the strainer. The tamper 250 may be positioned in a recess of the housing 210 during the grinding process, and is extended from this recess and returned to its position above the strainer 260 when the grinding process is complete. The tamper 260 may be a planar piston or an impeller. The tamper 260 exerts a force on and distributes ground coffee located in the strainer 270. Now a heated fluid, for example water, can be forced through the ground coffee in the strainer 260.

FIG. 3 shows a water reservoir 270 with a housing 271 in which water 276 is stored. A piston 273 is arranged in the housing, which can be moved in the housing by an actuator 275 and a rod 274. When the piston 273 is moved in the housing 271, the water 276 is forced through the outlet opening 277. A hose or pipe (not shown) is arranged at the outlet opening 277 and brings the water to the ground coffee in the strainer 260 (see FIG. 2).

The actuator 275 is also controlled by the control unit 220 to cause a desired flow profile and pressure of the water 276 through the outlet opening 277. The flow profile of the water and the pressure of the water is determined by the identification of the coffee bean container used.

Heating elements 272 are arranged at the water reservoir 270 to bring the water 276 to a desired temperature. This temperature can also be specified by the identification of the coffee bean container used.

For example, the water reservoir 270 has a holding capacity for water to make one serving of coffee drink. After the manufacturing process, the piston 273 is pulled away from the outlet opening 277 by the actuator 275. At this point, new water is introduced into the water reservoir 270, for example via an inlet opening (not shown separately) arranged in the wall of the housing 271.

FIG. 4 shows the control unit 220 and a first sensor 280 and a second sensor 290 associated therewith. The first sensor 280 may be arranged on the coffee machine 200 to sense a flow profile of water forced out of the water reservoir 270. The second sensor 290 may be arranged on the piston 273 or the actuator 275 to sense a movement or resistance of the piston 273 or the actuator 275, respectively.

Both the flow profile of the water and the resistance to movement of the piston 273 or actuator 275 can be used by the control unit 220 to determine how the water flows through the ground coffee contained in the strainer 260. The flow profile and the pressure of the water affect the taste of the coffee drink. Both may be predetermined for the particular coffee bean container 100 via the identification element 130 on the coffee bean container 100. If the flow profile and/or the pressure of the water deviates from these specifications, the control unit 220 can control the actuator 275 at the water reservoir 270 in such a way that these values adapt to the specifications.

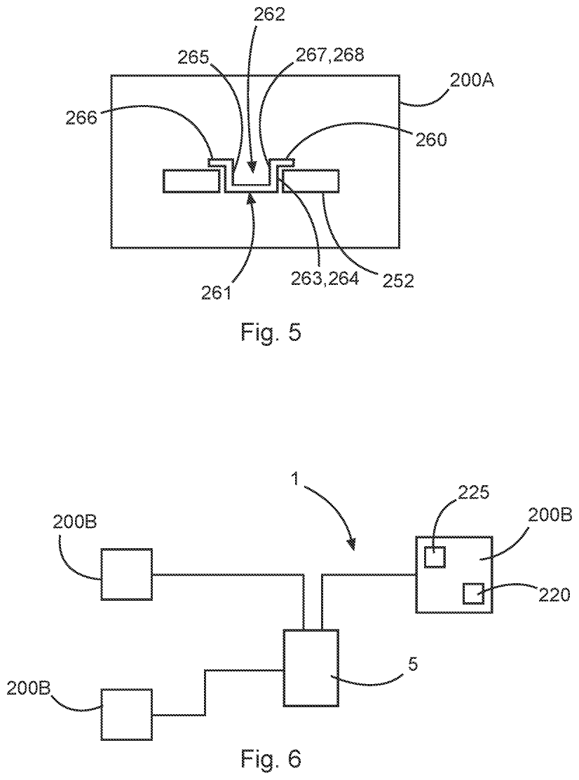

FIG. 5 shows a coffee machine 200A. This can be the coffee machine from the preceding embodiments or a coffee machine that does not implement or only partially implements the features described in FIGS. 1 to 4. The coffee machine 200A includes a support 252. The support 252 has an opening configured to receive the strainer 260 to enable preparation of a coffee drink. In the state shown in FIG. 5, the strainer at 160 is located in the support 252. In this state, heated or hot water is forced through ground coffee (not shown) located in the interior space 262. The water exits the interior space 262 through openings located in the base area 261 of the strainer 260 (not shown).

The strainer 260 has a substantially U-shaped profile with a base area 261, one or more lateral walls 265, and one or more shoulders 266. The lateral walls 265 together with the base area 261 form the interior space 262. The shoulder 266 rests on the support 252 in the inserted state and holds the strainer 260 in position.

In the example shown in FIG. 5, various surfaces of the strainer 260 abut the support 252. To reduce the amount of thermal energy transferred from the strainer to the support, an outer surface 263 of the lateral wall 265 is coated with a first coating 264. The first coating 264 is configured to be thermally insulating. For example, the first coating 264 is disposed on the outer surface of the lateral wall and on the underside of the shoulder. Generally speaking, the first coating 264 is disposed at the contact surfaces or contact points between the strainer 260 and the support 252.

The interior surface 267 of the screen 260 is coated with a second coating 268. The second coating serves to prevent adhesion of ground coffee after the preparation process of a coffee drink or to reduce the extent thereof. The second coating 267 is arranged, for example, on the interior surface of the lateral wall 265 and on the base area 261, and in particular extends over the entire interior surface of the strainer 260. The second coating 267 may also extend to the surface of the shoulder 266.

FIG. 6 shows an arrangement 1 with a plurality of coffee machines 200B and a central unit 5. The coffee machines 200B are communicatively connected to the central unit 5 via a data network or a data link, so that data can be exchanged bidirectionally between each individual coffee machine and the central unit. For example, a coffee machine from a household may be connected wireless or in a wired manner to an access node to the Internet (or another data network). The Internet (or another data network) establishes the connection to the remotely located central unit 5. The central unit 5 may provide selected individual or all coffee machines with information, such as new recipes or changes to existing recipes.

The central unit 5 may, for example, be designed as a computer or a computer arrangement to have sufficient computing power and transmission capacity to handle a connection to a high number of coffee machines.

Each coffee machine 200B has a control unit 220 which, on the one hand, applies the preparation parameters for a coffee drink and, on the other hand, receives measured values from a plurality of sensors distributed in the coffee machine (for example, the first sensor 280 and the second sensor 290 as well as further sensors as described herein), and the measured values in particular relate to the brew parameters. In addition, each coffee machine 200B includes an input/output unit or operating element 225 through which a user of the coffee machine can provide taste sensing input to a prepared coffee drink. The control unit 220 receives both the measured values and the taste sensor inputs and transmits them to the central unit 5.

The central unit 5 can also be configured to provide the preparation parameters to a coffee machine based on a read-out identification element 130 of the coffee bean container. For example, if a coffee bean container 100 is inserted into the coffee machine 200B and the identification element is read out, the coffee machine can retrieve the recipe with preparation parameters belonging to this identification element from the central unit 5. This means that it is not necessary for the recipe to be stored locally on the identification element or in the coffee machine. If the recipe is stored centrally and is retrieved as needed, a revision of the recipe will find its way to the individual coffee machines at an early stage. For example, the recipe can be retrieved by a coffee machine from the central unit whenever a coffee bean container is newly inserted or changed in said coffee machine. It is conceivable that the coffee machine has a memory which holds a fixed or variable number of most recently used recipes, whereby a recipe stored in this memory is provided with a time stamp, for example, and is deleted after a predeterminable period of time. However, a recipe can also be deleted from the memory if there is a need for storage space for more recently used recipes.

Additionally, it should be noted that “comprising” or “consisting” does not exclude other elements or steps, and “one” or “a” does not exclude a plurality. It should further be noted that features or steps that have been described with reference to any of the above embodiments may also be used in combination with other features or steps of other embodiments described above. Reference signs in the claims are not to be regarded as a limitation.

### LIST OF REFERENCE SIGNS

1 arrangement
5 central unit
10 system
100 coffee bean container
110 housing
120 outlet
125 closure
127 locking element
130 identification element
200 coffee machine
205 detection device
210 housing
220 control unit
225 input/output unit, operating element
230 grinder
232 grinding disc
234 free space
240 coffee bean container receiving arrangement
241 container holder
242 locking groove
243 closing device
244 receiving cup
245 actuator
246 receiving space
247 outlet opening
248 inlet opening
250 tamper
252 support
260 strainer
261 base area
262 interior space
263 outer surface
264 first coating
265 lateral wall
266 shoulder
267 interior surface
268 second coating
270 water reservoir
271 housing
272 heating element
273 piston
274 rod
275 actuator
276 water
277 outlet opening
280 first sensor
290 second sensor

1. A coffee machine comprising:
a housing; and
a coffee bean container receiving arrangement;
a grinder configured to grind coffee beans; and
a detection device;
wherein the coffee bean container receiving arrangement comprises:
a container holder configured to receive a coffee bean container; and
an actuator arranged and configured to move a closing device, disposed on one of the container holder and the coffee bean container, between an open state and a closed state and vice versa, wherein the closing device is configured to selectively close or release an inlet opening defined by one of the container holder or the coffee bean container;
wherein the actuator is configured to move the closing device from the open state to the closed state after an adjustable period of time in order to thereby preset a quantity of coffee beans that are fed to the grinder;
wherein the detection device is configured to detect and read an identification of the coffee bean container and
wherein the coffee machine is configured to adjust the adjustable period of time after the closing device is moved from the open state to the closed state depending on the detected identification of the coffee bean container.

2. The coffee machine of claim 1,
wherein the container holder encloses a receiving space for receiving the coffee beans;
wherein the actuator is further arranged to act on the container holder to change a size of the receiving space;
wherein the actuator is configured to, in response to the receiving space being filled with coffee beans, transition the closing device from the closed state to feed the coffee beans from the receiving space to the grinder.

3. The coffee machine of claim 2,
wherein the actuator is further configured to translate the container holder with respect to the housing to change the size of the receiving space.

4. The coffee machine of claim 2,
further comprising:
a receiving cup movably connected to the container holder,
wherein the receiving space is collectively defined by the receiving cup, the container holder, and the closing device being in the closed state.

5. The coffee machine of claim 1,
further comprising:
a strainer arranged to collect ground coffee from the grinder; and
a tamper configured to exert a compressive force on the ground coffee disposed in the strainer to cause a homogeneous surface and a homogeneous surface thickness of the ground coffee disposed in the strainer.

6. The coffee machine of claim 1,
wherein the coffee machine is configured to be selectively operated with one coffee bean container of a plurality of interchangeable coffee bean containers.

7. The coffee machine of claim 1,
further comprising:
a water reservoir provided with a housing and a piston, the piston configured to be driven by an actuator to move within the housing and to force a fluid, disposed in the housing, out of the housing through an outlet opening.

8. The coffee machine of claim 7,
further comprising:
at least one heating element disposed on the water reservoir and configured to heat the fluid disposed in the water reservoir to a predetermined temperature.

9. The coffee machine of claim 7,
further comprising:
a first sensor configured to detect a flow profile of the fluid at the outlet opening of the housing of the water reservoir.

10. A coffee bean container for use in a coffee machine, the coffee bean container comprising:
a housing configured to hold coffee beans;
an outlet configured to discharge the coffee beans from the housing; and
an identification element, the identification element being machine-readable and containing an instruction for setting parameters of the coffee machine, wherein the parameters are configured for preparing a coffee drink with the coffee beans from the housing;
wherein the identification element is configured to specify a first parameter of the parameters of the coffee machine, the first parameter being configured to instruct an actuator to move a closing device, disposed on one of a container holder of the coffee machine or the coffee bean container, from an open state to a closed state after an adjustable period of time, to feed a specified quantity of coffee beans to a grinder.

11. The coffee bean container of claim 10,
further comprising:
a locking element arranged to releasably lock the outlet to a container holder of a coffee machine.

12. The coffee bean container of claim 10,
further comprising:
a closure configured to be connected to a container holder of the coffee machine, in which the closure is configured to selectively transition from a closed state, in which the outlet of the coffee bean container is closed, and an open state in which the outlet of the coffee bean container is opened.

13. A system configured to prepare coffee drinks, the system comprising:
one or more coffee bean containers including the coffee bean container of claim 10.

14. The coffee machine of claim 5, wherein the strainer includes
a coating configured to provide a thermal insulation between the strainer and a strainer support of the coffee machine.

15. The coffee machine of claim 1, further comprising:
a control unit; and
at least one sensor, wherein the at least one sensor is configured to, during the preparation of a coffee drink, detect a brew parameter and transmit the brew parameter to the control unit, wherein the control unit is configured to, responsive to receiving the transmitted brew parameter from the at least one sensor, modify a recipe for the preparation of the coffee drink based on the detected transmitted brew parameter.

16. The coffee machine of claim 2, wherein the actuator is further configured to move a shell surface of the container holder to change the size of the receiving space.

17. The coffee machine of claim 9, further comprising:
a second sensor configured to sense a force applied by the actuator to the piston.

18. The system of claim 13 further comprising:
the coffee machine of claim 1.

19. The coffee bean container of claim 12, wherein the closure is configured to, in response to the coffee bean container not being connected to the container holder, close the housing.

20. The coffee bean container of claim 12, wherein the closure includes a number of closure plates configured to radially move to close the outlet.
